(19) United States
(12) Patent Application Publication
(10) Pub. No.: US 2026/0161887 A1
(43) Pub. Date: Jun. 11, 2026

(54) DATA-PROCESSING DEVICE

(71) Applicant: SHIMADZU CORPORATION, Kyoto-shi (JP)

(72) Inventor: Yuuji WATANABE, Kyoto-shi (JP)

(21) Appl. No.: 19/181,907

(22) Filed: Apr. 17, 2025

(30) Foreign Application Priority Data
Apr. 17, 2024 (JP) 2024-066634

(51) Int. Cl. G06F 40/186; G06F 40/106

(52) U.S. Cl. CPC G06F 40/186; G06F 40/106

(57) ABSTRACT

In order to reduce the workload of an operator in relation to the task of creating a template for an analysis report or system check report, a data-processing device is provided which includes: a report acquirer 31 configured to acquire an existing report including a plurality of report items concerning a predetermined analytical instrument 10; a layout analyzer 32 configured to execute the process of generating layout data from the existing report, using a trained model constructed by machine learning, the layout data showing the layout of the existing report including the plurality of report items; and a template generator 33 configured to generate, based on the layout data, a template to be used for creation of a new report.

### TECHNICAL FIELD

The present invention relates to a data-processing device.

### BACKGROUND ART

In recent years, the processing and management of various data acquired with a gas chromatograph, liquid chromatograph, mass spectrometer or other analytical instruments has been mostly performed by means of a computer on which dedicated software is installed. An analytical-instrument management system using such a computer is often equipped with the function of automatically creating an analysis report which shows a chromatogram, mass spectrum or other kinds of graph as well as numerical data (or the like) collected by an analysis. An analysis report includes various report items, such as sample information, analysis conditions or analysis results shown in the form of a graph or table (or the like). Each operator has specific preferences in terms of what report items should be arranged in what form in the analysis report. Accordingly, in an analytical-instrument management system equipped with such a report creation function, an operator previously prepares a template which specifies the arrangement of various report items in the analysis report and other settings and stores the template in the computer. When an analysis report is to be created¸ the operator selects the template for the report and the data file which contains the information to be reported and issues a command to create an analysis report. Consequently, an analysis report including the specified report items inserted at the specified position in the template is automatically created (for example, see Patent Literature 1).

### CITATION LIST

### PATENT LITERATURE

Patent Literature 1: JP 6645513 B

### SUMMARY OF INVENTION

### TECHNICAL PROBLEM

In the analytical-instrument management system having a report creation function as described earlier, when the analytical instrument to be managed is replaced with a new instrument or when the dedicated software is replaced with new software, it is necessary to create a template from scratch so that the same analysis report as used before can also be generated with the newly introduced analytical instrument or software. This task has been considerably burdensome for the management and operation of the system. The problem that a significant amount of time and labor is required for creating a template from scratch also exists in the case where the aforementioned type of analytical-instrument management system is newly introduced or the case where a new operator begins to use an existing system.

The previously described problem is not limited to an analysis report which shows the result of an analysis of a sample by an analytical instrument. The same problem similarly occurs with a system check report which shows the result of an operation check of an analytical instrument.

The present invention has been developed in view of the previously described point, and its objective is to reduce the workload of the operator in relation to the task of creating a template for an analysis report or system check report (or the like).

### SOLUTION TO PROBLEM

A data-processing device according to the present invention developed for solving the previously described problem includes:

a report acquirer configured to acquire an existing report including a plurality of report items concerning a predetermined analytical instrument;

a layout analyzer configured to execute the process of generating layout data from the existing report, using a trained model constructed by machine learning, the layout data showing the layout of the existing report including the plurality of report items; and

a template generator configured to generate, based on the layout data, a template to be used for the creation of a new report.

### ADVANTAGEOUS EFFECTS OF INVENTION

By the data-processing device according to the present invention, a template for creating a new report in a similar layout to the existing report can be easily created without requiring an operator to perform complex operations. Therefore, the workload of the operator in relation to the creation of a template can be reduced.

### BRIEF DESCRIPTION OF DRAWINGS

FIG. 1 is a schematic configuration diagram of an analyzing system including a data-processing device according to one embodiment of the present invention.

FIG. 2 is an example of image data of an existing report in the present embodiment.

FIG. 3 is a model diagram showing the layout data of the existing report.

FIG. 4 is a flowchart showing the procedure for generating a report template in the present embodiment.

FIG. 5 shows an example of image data of a reference report in the present embodiment.

FIG. 6 is a model diagram showing the layout data generated based on the reference report in FIG. 5.

FIG. 7 is a model diagram showing a report template generated based on the layout data in FIG. 6.

FIG. 8 shows another example of image data of a reference report in the present embodiment.

FIG. 9 is a model diagram showing the layout data generated based on the reference report in FIG. 8.

FIG. 10 is a model diagram showing a report template generated based on the layout data in FIG. 9.

### DESCRIPTION OF EMBODIMENTS

An embodiment of the data-processing device according to the present invention is hereinafter described with reference to the attached drawings.

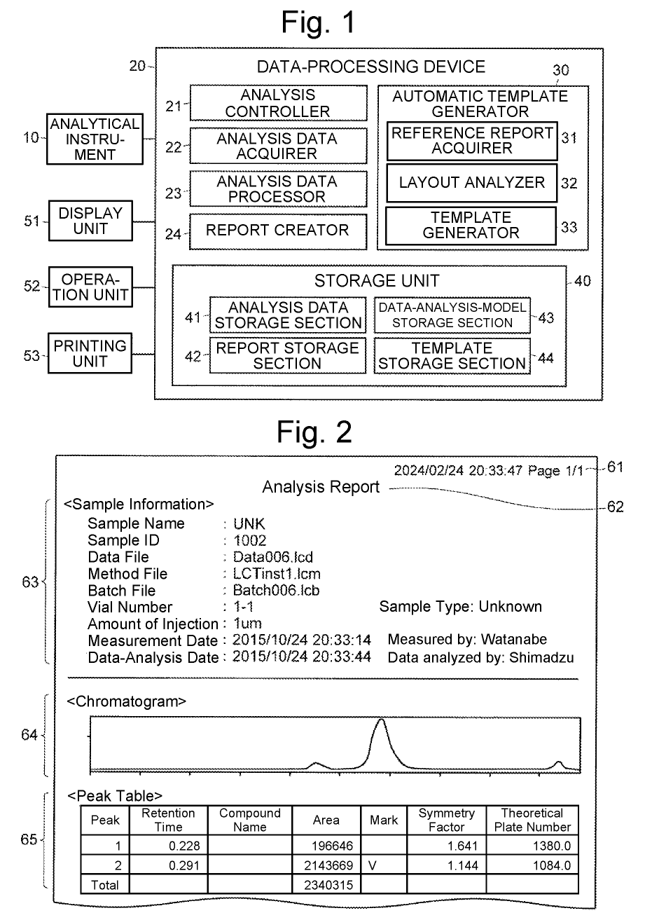

FIG. 1 is a schematic configuration diagram of an analyzing system including the data-processing device 20 according to the present embodiment. The analyzing system according to the present embodiment consists of an analytical instrument 10 and a data-processing device 20 connected to each other by a dedicated cable or through a LAN or similar network. The analytical instrument 10 carries out a physical or chemical analysis on a sample and collects data, while the data-processing device 20 processes output data from the analytical instrument 10. For convenience of description, it is hereinafter assumed that the analytical instrument 10 is a liquid chromatograph. However, the type of analytical instrument 10 in the present embodiment is not specifically limited; for example, it may also be a gas chromatograph, mass spectrometer or spectrophotometer. The number of analytical instruments 10 to be connected to the data-processing device 20 is not limited to one; there could be two or more instruments.

The data-processing device 20 includes, as its functional blocks, an analysis controller 21 configured to control the operation of the analytical instrument 10, an analysis data acquirer 22 configured to acquire output data from the analytical instrument 10 (which corresponds to the data acquirer in the present invention), an analysis data processor 23 configured to perform predetermined analytical processing based on the data, a report creator 24 configured to create an analysis report in which the result of the analysis by the analytical instrument 10 is described, and an automatic template generator 30 configured to generate a “report template”, i.e., a template to be used for the creation of the analysis report. The automatic template generator 30 further includes, as its sub-functional blocks, a reference report acquirer 31 (which corresponds to the report acquirer in the present invention), layout analyzer 32 and template generator 33.

The data-processing device 20 further has a storage unit 40. The storage unit 40 includes: an analysis data storage section 41 in which an analysis data file (which will be described later) will be stored; a report storage section 42 in which an analysis report created by the report creator 24 will be stored; a data-analysis-model storage section 43 in which a data-analysis model to be used in the layout analyzer 32 will be stored; and a template storage section 44 in which a report template generated by the automatic template generator 30 will be stored. The analysis data file to be stored in the analysis data storage section 41 is a file in which various kinds of information related to an analysis of a sample by the analytical instrument 10 are recorded. Examples of the “various kinds of information related to an analysis of a sample” include information entered by an operator for the execution of the analysis (e.g., information concerning the sample, analysis conditions in the analytical instrument 10, or data-analysis conditions in the analysis data processor 23), data outputted from the analytical instrument 10 and acquired by the analysis data acquirer 22 with the progress of the analysis, as well as various calculated values obtained by processing the output data in the analysis data processor 23 or processing results obtained by processing the output data in the analysis data processor 23.

The data-processing device 20 is actually a computer, such as a personal computer including a CPU and a memory as well as a large-capacity storage device, such as a hard disk drive (HDD) or solid-state drive (SSD). A predetermined program is pre-installed on the computer, and the CPU executes this program to embody the aforementioned functional blocks in the form of software components. The functions of the storage unit 40 are realized by the large-capacity storage device. A display unit 51 for showing various kinds of information, an operation unit 52 for allowing users to perform operations such as the input of various instructions, and a printing unit 53 are connected to the computer. For example, the display unit 51 may include a liquid crystal display, while the operation unit 52 may include a keyboard, a pointing device (e.g. mouse) or a touch panel additionally provided on the display unit 51.

It should be noted that the “computer” in the present context includes not only a standalone type of computer but also a computer system consisting of a plurality of computers connected to each other via a network. Accordingly, for example, it is possible to assign the functions of the analysis controller 21, analysis data acquirer 22, analysis data processor 23, report creator 24, analysis data storage section 41 and report storage section 42 to a first computer, while assigning the functions of the automatic template generator 30 and data-analysis-model storage section 43 to a second computer (e.g., a cloud server) connected to the first computer either directly or via LAN, the Internet or similar network. In this case, the function of the template storage section 44 may be assigned to any one of the first and second computers.

### Creation of Data-Analysis Model

As described earlier, a data-analysis model (which corresponds to the trained model in the present invention) to be used in the layout analyzer 32 is stored in the data-analysis-model storage section 43 of the data-processing device 20 according to the present embodiment. The “data-analysis model” in the present embodiment is a mathematical model for receiving an input of an image of an analysis report and outputting layout data showing the structure of the analysis report. This model is generated by machine learning. A method for generating this data-analysis model is hereinafter described.

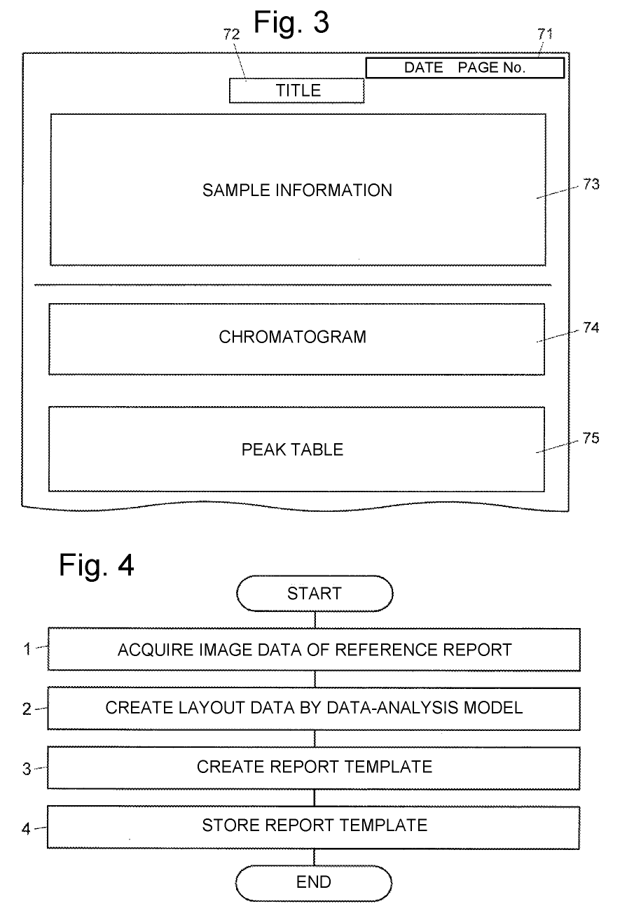

For the creation of a data-analysis model, an operator initially prepares, for various types of existing analysis reports (hereinafter called “existing reports”) created for an analytical instrument 10 for which a template should be created, image data of each existing report and layout data showing the structure of the existing report. The “layout data” in the present context is data which shows what kind of information is placed at which location in the existing report concerned. In other words, the data shows the kinds of report items included in the existing report concerned as well as the arrangement of those items. FIG. 2 shows an example of the image data of an existing report, and FIG. 3 shows an example of the layout data of the same existing report. As shown in FIG. 2, this existing report includes the following report items: created date and page number of the report (denoted by reference sign 61); title of the report (62); sample information (63), which is a set of information concerning the sample and the analysis conditions; chromatogram (64); and peak table (65) in which various items of information concerning the peaks included in the chromatogram 64 are described. The corresponding layout data is data which shows the layout of the existing report including the aforementioned report items, as shown in FIG. 3. Specifically, the layout data shows the horizontal and vertical sizes of each of the areas 71-75 in which the aforementioned report items are respectively shown (these areas are hereinafter called “description areas”), the arrangement of the description areas 71-75, the kind of report item shown in each description area 71-75 and other related items of information. A huge number of combinations of the image data and the layout data of existing reports are prepared and used as teaching data (which may also be called “learning data” or “training data”) to create a data-analysis model by a machine-learning algorithm. Various techniques have been known as algorithms of such a type of supervised machine learning, examples of which include support vector machine, random forest, GAN (generative adversarial networks), AdaBoost, naive Bayes, k-nearest neighbor, and deep learning including neural networks. Any of these techniques may be used in the present embodiment. For example, in the case of deep learning using a convolution neural network (CNN), the coefficients of a filter in each of a large number of convolution layers as well as the weighting factor at each node or in a fully connected layer are learned as CNN parameters.

### Creation of Report Template

Subsequently, the creation of a report template, which is a characteristic operation in the analyzing system according to the present embodiment, is described with reference to the flowchart in FIG. 4. In the data-processing device 20 according to the present embodiment, the automatic template generator 30 generates a report template based on an image of an analysis report prepared by the operator as a reference for the template creation (which is hereinafter called the “reference report”). The reference report does not always need to be an analysis report created as a result of an actual analysis using the analytical instrument 10; for example, it may be a virtual analysis report created by the operator using a word processor, spreadsheet, image editor or other types of software.

For the creation of a report template, the reference report acquirer 31 initially acquires image data of the reference report (Step 1). In this step, for example, the reference report acquirer 31 may acquire, as the image data of the reference report, image data of an analysis report specified by the operator from among a collection of image data of analysis reports previously stored in the storage unit 40, or it may acquire, as the image data of the reference report, a piece of image data acquired by scanning a predetermined analysis report with a scanner (not shown) connected to the computer.

The image data of the reference report acquired by the reference report acquirer 31 is fed into the layout analyzer 32. The layout analyzer 32 inputs the image data of the reference report into the data-analysis model described earlier and obtains layout data showing the structure of the reference report as an output from the data-analysis model (Step 2).

Subsequently, the template generator 33 creates a report template based on the layout data (Step 3). The report template is a model template to be used for the creation of a new analysis report (“new report”). This template includes one or more information insertion fields into which some information will be inserted as well as the specifications of those fields, such as the arrangement of the information insertion fields, the horizontal and vertical sizes of each information insertion field, and the type of report item to be inserted into each information insertion field.

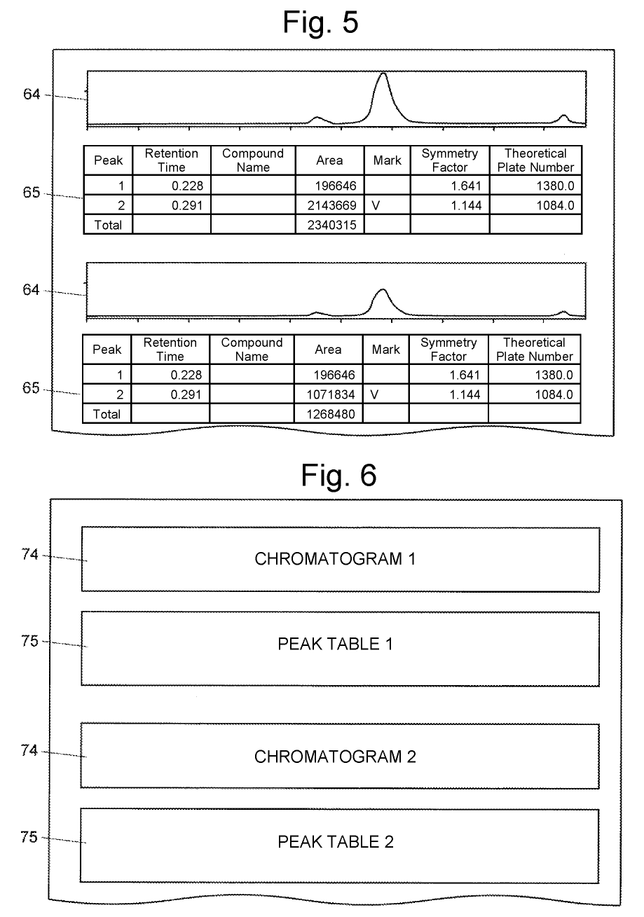

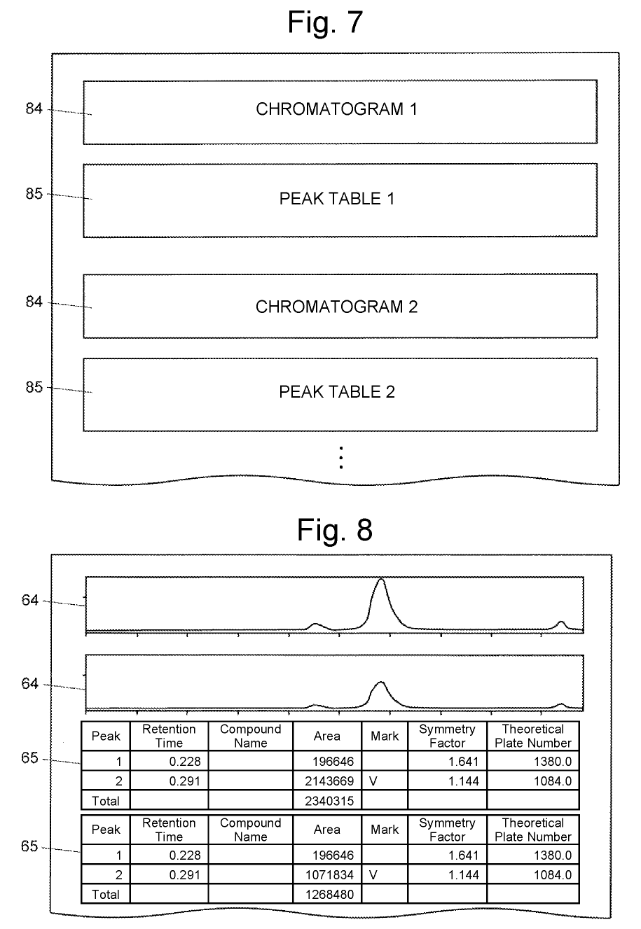

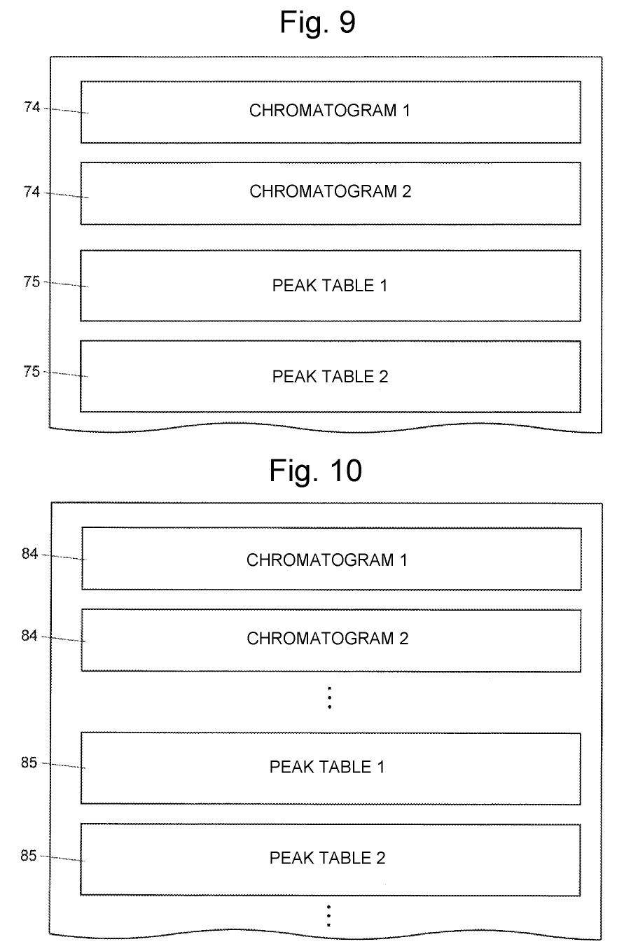

The aforementioned report template is created, for example, by converting the layout data generated in Step 2 into a file format that can be used for the creation of a new report in the report creator 24. If the layout data generated in Step 2 includes a repetition of the same kind of report item, the report template should reflect the repetitive pattern. Specifically, for example, if the reference report in Step 1 has two or more combinations of one chromatogram 64 and one peak table 65 vertically arranged as shown in FIG. 5, the layout data generated in Step 2 will include, as shown in FIG. 6, the same number of combinations of the chromatogram description area 74 and the peak-table description area 75 as the number of combinations of the chromatogram 64 and the peak table 65 in the reference report. The corresponding report template generated in Step 3 will include a directive which specifies that, as shown in FIG. 7, the combination of an information insertion field 84 into which a chromatogram will be inserted and an information insertion field 85 into which a peak table will be inserted should be vertically arranged the same number of times as the number of chromatograms and peak tables to be reported. As another example, as shown in FIG. 8, if the reference report in Step 1 has a plurality of chromatograms 64 (in FIG. 8, two chromatograms) with a plurality of peak tables 65 (in FIG. 8, two tables) located below in a vertically arranged form, the layout data generated in Step 2 will include, as shown in FIG. 9, the same number of chromatogram description areas 74 as the chromatograms 64 in the reference report, below which the same number of peak-table description areas 75 as the peak tables 65 in the reference report are located. The corresponding report template generated in Step 3 will include a directive which specifies that, as shown in FIG. 10, the information insertion field 84 into which a chromatogram will be inserted should be vertically arranged the same number of times as the number of chromatograms to be reported, below which the information insertion field 85 into which a peak table will be inserted should be vertically arranged the same number of times as the number of peak tables to be reported. The “number of chromatograms and peak tables to be reported” as well as the “number of chromatograms to be reported” and the “number of peak tables to be reported” mean the number of chromatograms and that of the peak tables included in an analysis data file designated as the target to be reported in the new report when a new report is created (as will be described later).

The report template to be used for the creation of a new analysis report is thus completed and stored in the template storage section 44 (Step 4).

### Creation of Analysis Report

When creating a new analysis report using the report template created in the previously described manner, the operator performs predetermined operations with the operation unit 52 to indicate the report template to be used for the creation of the report as well as the analysis data file containing the information to be included in the report and issues a command to execute the creation of the analysis report. Upon receiving this command, the report creator 24 reads the indicated report template from the template storage section 44 as well as the indicated analysis data file from the analysis data storage section 41. From the information contained in the analysis data file (i.e., the “various kinds of information related to an analysis of a sample” mentioned earlier), the report creator 24 extracts pieces of information which correspond to the kinds of report items designated to be inserted into the information insertion fields 84 and 85 on the report template and inserts those pieces of information into the respective information insertion fields 84 and 85 to create an analysis report. Consequently, a new analysis report is created in which the same kinds of report items as included in the reference report mentioned earlier are arranged in a similar layout to the reference report. The analysis report created in this manner is stored in the report storage section 42. The analysis report stored in the report storage section 42 can be displayed on the screen of the display unit 51 or printed with the printing unit 53 according to an instruction of the operator through the operation unit 52.

The description so far has been concerned with the case of creating an analysis report on an analysis performed in the past using the analytical instrument 10. This is not the only possible situation; the data-processing device 20 may also allow the operator to specify, before the execution of an analysis using the analytical instrument 10, the report template to be used for the creation of an analysis report and the analysis data file to be used for storing the data related to the analysis which is going to be performed, and the report creator 42 may automatically create an analysis report after the completion of the analysis.

One embodiment of the present invention has been described so far taking a specific example. It should be noted that the present invention is not limited to the previous embodiment; appropriate changes or modifications are also allowed within the spirit of the present invention. For example, although the previous embodiment assumed that the present invention is applied in the creation of a template for an analysis report showing the result of an analysis of a sample by the analytical instrument 10 as well as the creation of a new analysis report using that template, the present invention is not limited to this case and can also be similarly applied in the creation of a template of a report showing information concerning an operation check for determining whether or not the analytical instrument 10 is in normally operable conditions (i.e., the system check report) as well as the creation of a new system check report using the same template. Examples of the “information concerning an operation check” include information entered by the operator for executing the operation check (e.g., the operational conditions of the analytical instrument 10), data outputted from the analytical instrument 10 with the progress of the operation check and acquired by the analysis data acquirer 22, as well as various calculated values obtained by processing the output data in the analysis data processor 23 or processing results obtained by processing the output data in the analysis data processor 23. When the present invention is applied in such cases as the creation of a template for a system check report, a data-analysis model is constructed beforehand by machine learning in which image data of existing system check reports and the corresponding layout data are used as teaching data, and the constructed model is stored in the data-analysis-model storage section 43. As for the reference report in the creation of a report template, an existing system check report that can serve as a reference for the creation of the template should be used.

In the previous embodiment, the data-analysis model was configured to receive an input of image data of a reference report and output layout data of the same reference report. The present invention is not limited to this configuration; the data-analysis model may also be configured to create layout data of a reference report based on data of the reference report prepared in a predetermined file format (e.g., pdf format) other than image files. For the creation of this type of data-analysis model, the combination of the data in the predetermined file format of the existing reports and the corresponding layout data should be used as teaching data in machine learning in place of the previously described combination of the image data of the existing reports and the corresponding layout data.

In the previous embodiment, it was assumed that the program for realizing the functions of the data-processing device 20 was previously installed on the computer. The program can also be provided in the form of a non-transitory computer-readable medium recording the same program.

### Modes

It is evident to a person skilled in the art that the previously described illustrative embodiment is a specific example of the following modes of the present invention.

(Clause 1) A data-processing device according to one mode of the present invention includes:

a report acquirer configured to acquire an existing report including a plurality of report items concerning a predetermined analytical instrument;

a layout analyzer configured to execute the process of generating layout data from the existing report, using a trained model constructed by machine learning, the layout data showing the layout of the existing report including the plurality of report items; and

a template generator configured to generate, based on the layout data, a template to be used for the creation of a new report.

By the data-processing device according to Clause 1, a template for creating a new report in a similar layout to the existing report can be easily created without requiring an operator to perform complex operations. Therefore, the workload of the operator in relation to the creation of a template for an analysis report or system check report (or the like) can be reduced.

(Clause 2) The data-processing device according to Clause 2, which is a data-processing device according to Clause 1, further includes:

a data acquirer configured to acquire data outputted from the predetermined analytical instrument; and

a report creator configured to create the new report by inserting, into the template, the data acquired by the data acquirer or a processing result obtained by performing predetermined processing on the data.

The data-processing device according to Clause 2 can automatically perform the task of creating a new report using the template, and therefore can even more reduce the workload of the operator.

(Clause 3) In the data-processing device according to Clause 3, which is a data-processing device according to Clause 1 or 2, the template generator is configured so that, when the layout data includes a description which shows that a predetermined kind of report item occurs a plurality of times in the existing report, the template generator includes, in the template, a directive which specifies that the predetermined kind of report item should occur in the new report the same number of times as the number of pieces of data that correspond to the predetermined kind of report item and are designated as data to be included in the new report.

According to Clause 3, when the predetermined kind of report item occurs a plurality of times in the existing report, the data-processing device can create a template from which a new report can be created in an appropriate layout regardless of the number of pieces of data corresponding to the report item to be included in the report.

(Clause 4) A program according to Clause 4 is configured to cause a computer to function as:

a report acquirer configured to acquire an existing report including a plurality of report items concerning a predetermined analytical instrument;

a layout analyzer configured to execute the process of generating layout data from the existing report, using a trained model constructed by machine learning, the layout data showing the layout of the existing report including the plurality of report items; and

a template generator configured to generate, based on the layout data, a template to be used for the creation of a new report.

### REFERENCE SIGNS LIST

10 … Analytical Instrument

20 … Data-Processing Device

21 … Analysis Controller

22 … Analysis Data Acquirer

23 … Analysis Data Processor

24 … Report Creator

30 … Automatic Template Generator

31 … Reference Report Acquirer

32 … Layout Analyzer

33 … Template Generator

40 … Storage Unit

41 … Analysis Data Storage Section

42 … Report Storage Section

43 … Data-Analysis-Model Storage Section

44 … Template Storage Section

51 … Display Unit

52 … Operation Unit

53 … Printing Unit

63 … Sample Information

64 … Chromatogram

65 … Peak Table

71-75 … Description Area

84, 85 … Information Insertion Field

1. A data-processing device, comprising:
a report acquirer configured to acquire an existing report including a plurality of report items concerning a predetermined analytical instrument;
a layout analyzer configured to execute a process of generating layout data from the existing report, using a trained model constructed by machine learning, the layout data showing a layout of the existing report including the plurality of report items; and
a template generator configured to generate, based on the layout data, a template to be used for creation of a new report.

2. The data-processing device according to claim 1, further comprising:
a data acquirer configured to acquire data outputted from the predetermined analytical instrument; and
a report creator configured to create the new report by inserting, into the template, the data acquired by the data acquirer or a processing result obtained by performing predetermined processing on the data.

3. The data-processing device according to claim 1, wherein the template generator is configured so that, when the layout data includes a description which shows that a predetermined kind of report item occurs a plurality of times in the existing report, the template generator includes, in the template, a directive which specifies that the predetermined kind of report item should occur in the new report a same number of times as a number of pieces of data that correspond to the predetermined kind of report item and are designated as data to be included in the new report.

4. A non-transitory computer readable medium recording a program configured to cause a computer to function as:
a report acquirer configured to acquire an existing report including a plurality of report items concerning a predetermined analytical instrument;
a layout analyzer configured to execute a process of generating layout data from the existing report, using a trained model constructed by machine learning, the layout data showing a layout of the existing report including the plurality of report items; and
a template generator configured to generate, based on the layout data, a template to be used for creation of a new report.
